(19) United States
(12) Patent Application Publication
(10) Pub. No.: US 2025/0239094 A1
(43) Pub. Date: Jul. 24, 2025

(54) IMAGE CAPTION GENERATION METHOD, DEVICE, AND COMPUTER STORAGE MEDIUM

(71) Applicant: Hangzhou Alibaba International Internet Industry Co., Ltd., Hangzhou (CN)

(72) Inventors: Yanjing WU, Hangzhou (CN); Kuilong LIU, Hangzhou (CN); Changyuan YANG, Hangzhou (CN)

(21) Appl. No.: 19/065,472

(22) Filed: Feb. 27, 2025

Related U.S. Application Data
(63) Continuation of application No. PCT/CN2023/071971, filed on Jan. 12, 2023.

(30) Foreign Application Priority Data
Aug. 31, 2022 (CN) 202211056759.2

(51) Int. Cl. G06V 20/70; G06V 10/26; G06V 10/75; G06V 10/764; G06V 20/40

(52) U.S. Cl. CPC G06V 20/70; G06V 10/26; G06V 10/751; G06V 10/764; G06V 20/41; G06V 20/46

(57) ABSTRACT

The present application provides a method for device, and computer storage medium for generating an image caption. The method comprises: obtaining an image to be processed and auxiliary caption information, wherein the image to be processed includes a main object, and the auxiliary caption information includes at least one of the following: name information corresponding to the main object, object category corresponding to the main object, an object attribute corresponding to the main object, and an image tag corresponding to the image to be processed; determining an image feature corresponding to the image to be processed, and an auxiliary feature corresponding to the auxiliary caption information; generating the caption based on the image feature and the auxiliary feature to obtain a target caption corresponding to the image to be processed, wherein the target caption includes the name information of the main object.

This application is a Continuation Application of International Patent Application No. PCT/CN2023/071971, filed on Jan. 12, 2023, which is based on and claims priority to and benefits of Chinese Patent Application No. 202211056759.2, entitled “Image Caption Generation Method for Device, and Computer Storage Medium,” filed with the China National Intellectual Property Administration (CNIPA) on Aug. 31, 2022. The entire content of all of the above identified applications is incorporated herein by reference.

### TECHNICAL FIELD

The present invention relates to the field of image processing, and more specifically, to a method for device, and computer-readable storage medium for generating image captions.

### BACKGROUND

In the context of e-commerce applications, a single product image typically contains various types of information, such as the main product, models, and auxiliary products. When displaying such product images, due to the abundance of information, merely presenting the product image to the user may make it difficult for the user to immediately grasp the intended focus of the image. Therefore, it is necessary to pair the displayed image with appropriate captions, allowing the user to quickly understand the key content the image intends to convey by reading the caption related to the main product. Currently, captions for images must be manually written, which is not only time-consuming and labor-intensive but also inefficient, making it unable to meet the demands of large-scale production.

### SUMMARY

The embodiments of the present invention provide a method, device, and computer-readable storage medium for generating image captions. This solution enables the automatic generation of image captions by incorporating auxiliary caption information from a plurality of dimensions, thereby improving the quality and efficiency of caption generation.

In a first aspect, the embodiments of the present invention provide a method for generating an image caption, including:
obtaining an image to be processed and auxiliary caption information, wherein the image to be processed includes a main object, and the auxiliary caption information includes at least one of the following: name information corresponding to the main object, object category corresponding to the main object, an object attribute corresponding to the main object, and an image tag corresponding to the image to be processed;
determining an image feature corresponding to the image to be processed, and an auxiliary feature corresponding to the auxiliary caption information;
generating, based on the image feature and the auxiliary feature, a target caption corresponding to the image to be processed, wherein the target caption includes the name information of the main object.

In a second aspect, the embodiments of the present invention provide a device for generating an image caption, which includes:
a first obtaining module, configured to obtain an image to be processed and auxiliary caption information, wherein the image to be processed includes a main object, and the auxiliary caption information includes at least one of the following: name information corresponding to the main object, object category corresponding to the main object, an object attribute corresponding to the main object, and an image tag corresponding to the image to be processed;
a first determination module, configured to determine an image feature corresponding to the image to be processed, and an auxiliary feature corresponding to the auxiliary caption information;
a first processing module, configured to generate, based on the image feature and the auxiliary feature, a target caption corresponding to the image to be processed, wherein the target caption includes the name information of the main object.

In a third aspect, the embodiments of the present invention provide an electronic device, which includes: a memory and a processor. The memory is configured to store one or more computer instructions, wherein, when executed by the processor, the one or more computer instructions implement the method for generating image captions as described in the first aspect above.

In a fourth aspect, the embodiments of the present invention provide a computer storage medium configured to store a computer program, which, when executed by a computer, implements the method for generating image captions as described in the first aspect above.

In a fifth aspect, the embodiments of the present invention provide a computer program product, comprising a computer-readable storage medium storing computer instructions, which, when executed by one or more processors, cause the one or more processors to perform the steps of the method for generating image captions as described in the first aspect above.

In a sixth aspect, the embodiments of the present invention provide a method for generating video captions, which includes:
obtaining a video to be processed;
identifying a plurality of keyframes corresponding to the video to be processed, as well as auxiliary caption information, wherein the keyframes include a main object, and the auxiliary caption information includes at least one of the following: name information corresponding to the main object, object category corresponding to the main object, object attribute corresponding to the main object, video tag corresponding to the video to be processed, and voice information corresponding to the video to be processed;
determining image features corresponding to each of the plurality of keyframes, and auxiliary features corresponding to the auxiliary caption information;
generating, based on the image features and the auxiliary features, a target caption corresponding to the video to be processed, wherein the target caption includes the name information of the main object.

In a seventh aspect, the embodiments of the present invention provide a device for generating video captions, which includes:
a second obtaining module, configured to obtain a video to be processed;
a second determination module, configured to identify a plurality of keyframes corresponding to the video to be processed, as well as auxiliary caption information, wherein the keyframes include a main object, and the auxiliary caption information includes at least one of the following: name information corresponding to the main object, object category corresponding to the main object, object attribute corresponding to the main object, video tag corresponding to the video to be processed, and voice information corresponding to the video to be processed;
the second determination module being further configured to determine image features corresponding to each of the plurality of keyframes, and auxiliary features corresponding to the auxiliary caption information;
a second processing module, configured to generate, based on the image features and the auxiliary features, a target caption corresponding to the video to be processed, wherein the target caption includes the name information of the main object.

In an eighth aspect, the embodiments of the present invention provide an electronic device, which includes: a memory and a processor. The memory is configured to store one or more computer instructions, wherein, when executed by the processor, the one or more computer instructions implement the method for generating a video caption as described in the sixth aspect above.

In a ninth aspect, the embodiments of the present invention provide a computer-readable storage medium for storing a computer program, which, when executed by a computer, implements the method for generating a video caption as described in the sixth aspect above.

In a tenth aspect, the embodiments of the present invention provide a computer program product, comprising a computer-readable storage medium storing computer instructions, which, when executed by one or more processors, cause the one or more processors to perform the steps of the method for generating a video caption as described in the sixth aspect above.

In an eleventh aspect, the embodiments of the present invention provide a method for generating a captions for a live-stream image, which includes:
obtaining a live-stream image and auxiliary caption information, wherein the live-stream image includes a live-stream object, and the auxiliary caption information includes at least one of the following: name information corresponding to the live-stream object, object category corresponding to the live-stream object, object attribute corresponding to the live-stream object, and image tag corresponding to the live-stream image;
determining an image feature corresponding to the live-stream image, and an auxiliary feature corresponding to the auxiliary caption information;
generating, based on the image feature and auxiliary feature, a target caption corresponding to the live-stream image, wherein the target caption includes the name information of the live-stream object.
In a twelfth aspect, the embodiments of the present invention provide a device for generating a caption for a live-stream image, which includes:
a third obtaining module, configured to obtain a live-stream image and auxiliary caption information, wherein the live-stream image includes a live-stream object, and the auxiliary caption information includes at least one of the following: name information corresponding to the live-stream object, object category corresponding to the live-stream object, object attribute corresponding to the live-stream object, and image tag corresponding to the live-stream image;
a third determination module, configured to determine an image feature corresponding to the live-stream image, and an auxiliary feature corresponding to the auxiliary caption information;
a third processing module, configured to generate, based on the image feature and auxiliary feature, a target caption corresponding to the live-stream image, wherein the target caption includes the name information of the live-stream object.

In a thirteenth aspect, the embodiments of the present invention provide an electronic device, which includes: a memory and a processor. The memory is configured to store one or more computer instructions, wherein, when executed by the processor, the one or more computer instructions implement the method for generating a caption for a live-stream image as described in the eleventh aspect above.

In a fourteenth aspect, the embodiments of the present invention provide a computer-readable storage medium for storing a computer program, which, when executed by a computer, implements the method for generating a caption for a live-stream image as described in the eleventh aspect above.

In a fifteenth aspect, the embodiments of the present invention provide a computer program product, comprising a computer-readable storage medium storing computer instructions, which, when executed by one or more processors, cause the one or more processors to perform the steps of the method for generating a caption for a live-stream image as described in the eleventh aspect above.

The technical solution provided in this embodiment involves acquiring the image to be processed and the auxiliary caption information, followed by determining the image features corresponding to the image to be processed, as well as the auxiliary features corresponding to the auxiliary caption information. Based on these image features and auxiliary features, caption generation is performed to obtain one or more relatively accurate target captions corresponding to the image to be processed. The generated target caption includes the name information of the main object, thereby effectively achieving the automatic generation of image captions and meeting the demand for bulk caption generation. Moreover, since the target captions are generated by incorporating auxiliary caption information from a plurality of dimensions, this ensures the accuracy and quality of the generated captions. Once the target captions are obtained, they can be displayed together with the image to be processed, allowing users to intuitively and quickly understand the information conveyed by the image. This further enhances the practicality of the method and is beneficial for its promotion and application in the market.

### BRIEF DESCRIPTION OF THE DRAWINGS

To more clearly illustrate the technical solutions of the embodiments of the present invention or the prior art, a brief introduction to the accompanying drawings required in the description of the embodiments or the prior art is provided below. It is evident that the accompanying drawings described below are related to some embodiments of the present invention. For those skilled in the art, other drawings may also be obtained based on these drawings without the need for creative efforts.

FIG. 1 is a schematic diagram illustrating the principles of a method for generating image captions according to an embodiment of the present invention;

FIG. 2 is a flowchart illustrating a method for generating image captions according to an embodiment of the present invention;

FIG. 3 is a flowchart illustrating the process of determining auxiliary features corresponding to the auxiliary caption information according to an embodiment of the present invention;

FIG. 4 is a flowchart illustrating another method for generating image captions according to an embodiment of the present invention;

FIG. 5 is a flowchart illustrating a method for generating image captions in an application scenario according to an embodiment of the present invention;

FIG. 6 is a flowchart illustrating a method for generating video captions according to an embodiment of the present invention;

FIG. 7 is a flowchart illustrating a method for generating captions for live-stream images according to an embodiment of the present invention;

FIG. 8 is a schematic diagram illustrating the structure of a device for generating image captions according to an embodiment of the present invention;

FIG. 9 is a schematic diagram illustrating the structure of electronic equipment corresponding to the device for generating image captions shown in FIG. 8;

FIG. 10 is a schematic diagram illustrating the structure of a device for generating video captions according to an embodiment of the present invention;

FIG. 11 is a schematic diagram illustrating the structure of electronic equipment corresponding to the device for generating video captions shown in FIG. 10;

FIG. 12 is a schematic diagram illustrating the structure of a device for generating captions for live-stream images according to an embodiment of the present invention;

FIG. 13 is a schematic diagram illustrating the structure of electronic equipment corresponding to the device for generating captions for live-stream images shown in FIG. 12.

### DETAIL DESCRIPTION OF THE EMBODIMENTS

To make the objectives, technical solutions, and advantages of the embodiments of the present invention clearer, the technical solutions of the embodiments of the present invention will be described clearly and comprehensively below in conjunction with the accompanying drawings of the embodiments. It is evident that the described embodiments represent part of the embodiments of the present invention, rather than all of them. Based on the embodiments of the present invention, all other embodiments obtained by those skilled in the art without any creative efforts shall fall within the scope of protection of the present invention.

The terminology used in the embodiments of the present invention is solely for the purpose of describing specific embodiments and is not intended to limit the scope of the invention. In the embodiments of the present invention and the appended claims, the singular forms of “a” or “the” are intended to include the plural forms as well, unless the context clearly indicates otherwise. The terms “multiple” and “a plurality” generally include at least two, but does not exclude the possibility of including only one.

It should be understood that the term “and/or” used herein is intended to describe a relationship between associated objects, indicating that three possible relationships may exist. For example, “A and/or B” can indicate: the presence of A alone, the presence of both A and B, or the presence of B alone. Additionally, the character “/” used herein generally denotes an “or” relationship between the associated objects mentioned before and after it.

Depending on the context, the terms “if” or “when,” as used herein, may be interpreted as “upon” or “in response to determining” or “in response to detecting.” Similarly, depending on the context, the phrases “if it is determined” or “if it is detected (the stated condition or event)” may be interpreted as “when it is determined” or “in response to determining” or “when it is detected (the stated condition or event)” or “in response to detecting (the stated condition or event).”

It should also be noted that the terms “comprise,” “include,” or any of their variations are intended to encompass a non-exclusive inclusion, such that a product or system that includes a set of elements not only contains those elements but may also include other elements not expressly listed or elements inherent to such a product or system. Unless otherwise specified, an element defined by the phrase “comprising a . . . ” does not exclude the presence of additional identical elements in the product or system that includes the element.

Additionally, the sequence of steps in the following method embodiments is provided merely as an example and is not strictly limited to the order presented.

### Term Definitions:

M6: Multi-Modality to Multi-Modality Multitask Mega-transformer, a large-scale Chinese pre-trained model.
M6-OFA: a multimodal sequence-to-sequence algorithm framework that unifies a plurality of tasks.
Bert: Bidirectional Encoder Representation from Transformers, a pre-trained language representation model.
Resnet: Residual Network, a deep residual network that introduces residual units to effectively address the degradation problem in deep networks.
Transformer: a model entirely based on the attention mechanism, which is highly efficient and can be applied in various fields such as sentence translation and sentence generation.
CIDEr: A metric specifically used for evaluating image captioning tasks, which calculates the cosine similarity between reference descriptions and descriptions generated by the model.
N beamsearch: A heuristic search algorithm that, at each step, retains only the top N results with the highest probabilities.

To facilitate the understanding of the specific implementation process and effects of the method, device, and computer-readable storage medium for generating image captions described in this embodiment, a brief explanation of the relevant technologies is provided below:
in e-commerce scenarios, a single product image typically contains a plurality of types of information, such as the main product, models, and auxiliary products, which are then displayed to provide users with relevant product information. However, simply displaying the product image may make it difficult for users to immediately capture the key product being showcased in the image. Therefore, it is necessary to pair the displayed image with appropriate captions, allowing users to quickly understand the intended message by reading captions related to the main product in the image. Currently, image captions need to be manually written, which is time-consuming, labor-intensive, and inefficient, making it difficult to meet the demands of large-scale production.

To overcome the inefficiency of manually editing captions, relevant technology provides a method for generating image captions based on a two-stage model. The specific implementation process includes the following steps:

First stage: a deep residual network (Resnet) is used to extract product tags from the product image. Specifically, the product tags are obtained by querying a selling point word bank based on the extracted product tags and then ranking them according to frequency.

Second stage: the extracted product tag information is input into a text generation model to perform caption prediction, resulting in the generation of the image caption.

In the aforementioned image caption generation method, since the captions generated in the second stage rely on the product tags identified in the first stage, there is a potential issue of error propagation. Additionally, the generated image captions often do not include the name of the main product, making it less convenient for users to directly understand the primary information conveyed by the image.

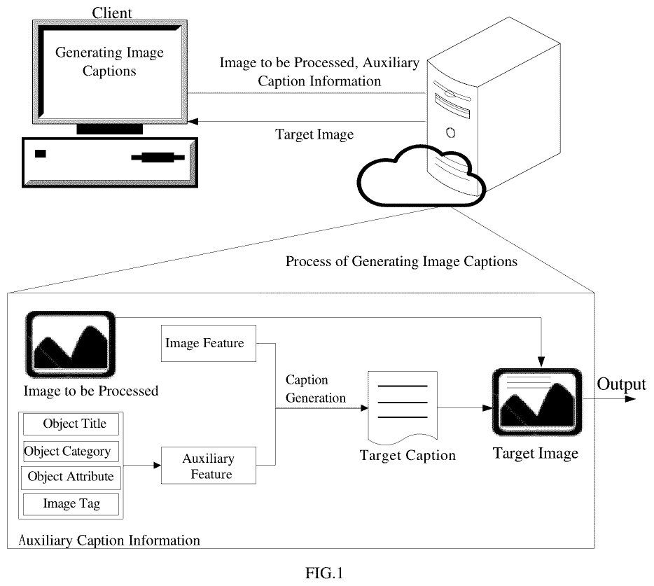

To address the aforementioned technical issues, this embodiment provides an end-to-end method for generating image captions. This method can automatically identify the main object in the image and generate one or more captions describing the characteristics of the main product. Referring to FIG. 1, the execution entity of the image caption generation method in this embodiment is an image caption generation device. It is important to note that this device can generate target captions based on the provided information without relying on other models or any middleware, thus achieving an end-to-end image caption generation process. Specifically, the image caption generation device can be implemented as a cloud-based server. In this case, the image caption generation method can be executed on the cloud, where a plurality of computing nodes (cloud servers) are deployed, each equipped with processing resources such as computation and storage. In the cloud, these nodes can be organized to provide a specific service, though a single computing node can also provide one or more services. The cloud offers this service by exposing service interfaces that users can call to access the corresponding service. These service interfaces may include Software Development Kits (SDKs) or Application Programming Interfaces (APIs).

The image caption generation device can be in communication with a client or a request endpoint. In the solution provided by the embodiments of this invention, the cloud offers a service interface for generating image captions. Users can trigger a request to the cloud by calling this image caption generation interface through the client/request endpoint. The cloud then identifies a computing node to respond to the request and utilizes the processing resources of that node to execute the specific operations required for generating the image caption.

The client/request endpoint can be any computing device with sufficient data transmission capabilities. Specifically, the client/request endpoint could be a mobile phone, personal computer (PC), tablet, or a device running a designated application. The basic structure of the client may include at least one processor, the number of which depends on the configuration and type of the client. The client may also include memory, which can be volatile, such as RAM, or non-volatile, such as Read-Only Memory (ROM), flash memory, or a combination of both. The memory typically stores an operating system (OS), one or more applications, and possibly program data. In addition to processing units and memory, the client includes basic components like a network card, I/O bus, display components, and various peripheral devices. Optionally, these peripheral devices may include a keyboard, mouse, stylus, printer, among others. Other peripheral devices are well known in the field and will not be elaborated on here.

The image caption generation device refers to equipment that can provide image caption generation services in a networked virtual environment. Typically, it involves devices that perform information processing and image caption generation tasks over a network. In terms of physical implementation, the image caption generation device can be any equipment capable of providing computing services, responding to image caption generation requests, and generating image captions based on these requests. Examples of such devices include cluster servers, conventional servers, cloud servers, cloud hosts, or virtual centers. The main components of the image caption generation device are similar to a general computer architecture and typically include a processor, hard drive, memory, system bus, and other essential components.

In the embodiment described above, the client/request endpoint can connect to the image caption generation device via a network, which can be either a wireless or wired network connection. If the client/request endpoint and the image caption generation device are connected through communication, the mobile network standard can be any of the following: 2G (GSM), 2.5G (GPRS), 3G (WCDMA, TD-SCDMA, CDMA2000, UTMS), 4G (LTE), 4G+ (LTE+), WiMax, 5G, 6G, or any other network standard.

In this embodiment, the client/request endpoint can obtain a request for generating an image caption. This request may include the image to be processed and auxiliary caption information. The image to be processed includes a main object, which may be the same or different across various scenarios. For example, the image may include food, clothing, electronic products, and so on. To enhance the quality and effectiveness of the image caption generation, the auxiliary caption information may include at least one of the following: name information corresponding to the main object, object category corresponding to the main object, object attributes corresponding to the main object, and image tags corresponding to the image to be processed; specifically, the object category is used to identify the category of the main object, which may include categories such as food, clothing, or electronic devices; object attributes may include regional attributes, quality attributes, functional attributes, and more.

Specifically, the embodiments do not limit the specific method by which the request endpoint obtains the image to be processed and the auxiliary caption information. In some instances, the request endpoint may be equipped with an interactive interface, through which it can obtain the user's input for executing operations. Based on the user's input, the system can acquire the image to be processed and the auxiliary caption information. In other instances, the image to be processed and the auxiliary caption information may be stored on a third device that is in communication with the request endpoint. The request endpoint can actively or passively obtain the image and auxiliary information from the third device. After acquiring the image to be processed and the auxiliary caption information, the request endpoint can send them to the image caption generation device, allowing the device to generate image captions based on the provided image and auxiliary information.

The image caption generation device is used to obtain the image to be processed and the auxiliary caption information. It can separately analyze and process the image and the auxiliary information to determine the image features corresponding to the image, as well as the auxiliary features corresponding to the auxiliary caption information; then, based on the image features and auxiliary features, the device performs caption generation, resulting in a target caption corresponding to the image. The target caption includes the name information of the main object, thereby completing the image caption generation process.

In some embodiments, after obtaining the target caption corresponding to the image to be processed, and in order to enhance the practicality of the method, this embodiment can also include the following step: integrating the target caption with the image to be processed to generate a target image. In this case, the target image will include the target caption.

The technical solution provided in this embodiment involves obtaining the image to be processed and the auxiliary caption information, followed by determining the image features corresponding to the image and the auxiliary features corresponding to the auxiliary caption information. Based on these image features and auxiliary features, the system performs caption generation, resulting in one or more relatively accurate target captions corresponding to the image. The generated target caption includes the name information of the main object, effectively automating the image caption generation process, making this solution suitable for batch caption generation scenarios. Furthermore, since the target captions are generated using auxiliary information from a plurality of dimensions, the accuracy and quality of the generated captions are ensured. Once the target captions are obtained, they can be displayed alongside the image to allow users to intuitively and quickly grasp the information conveyed by the image. This significantly enhances the practicality of the method and facilitates its promotion and application in the market.

The following section provides a detailed description of certain embodiments of the present invention in conjunction with the accompanying drawings. Where there is no conflict between embodiments, the embodiments and features described below can be combined with each other. Additionally, the sequence of steps in the method embodiments provided below is presented as an example and is not strictly limited to the order shown.

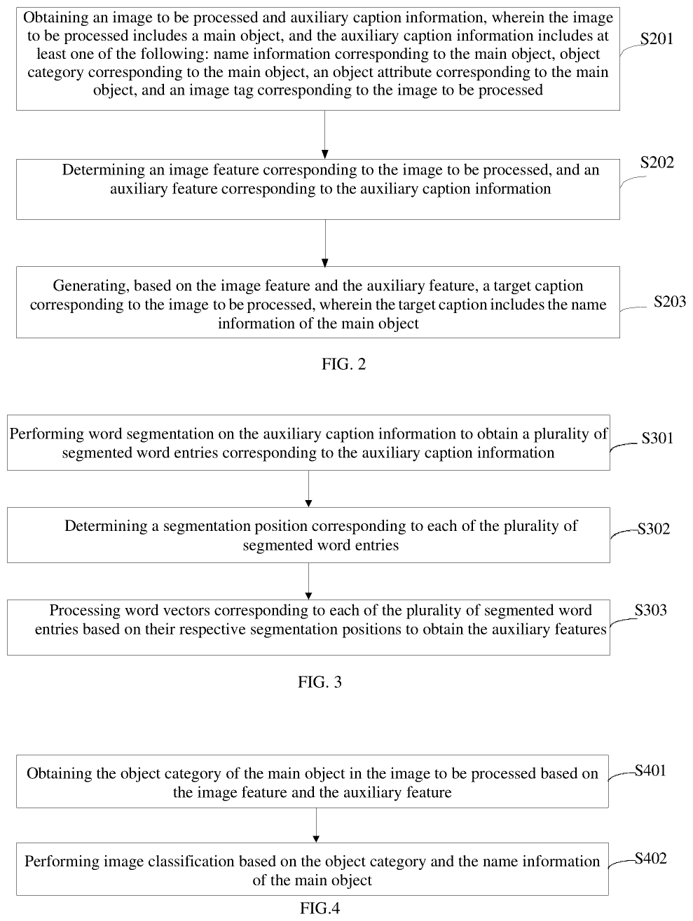

FIG. 2 is a flowchart illustrating the method for generating image captions provided by an embodiment of the present invention. Referring to FIG. 2, this embodiment provides a method for generating image captions, with the execution entity being an image caption generation device. It should be understood that the image caption generation device may be implemented as software or a combination of software and hardware. Specifically, when the image caption generation device is implemented as hardware, it can be any electronic device capable of performing image caption generation operations, including but not limited to tablets, personal computers (PCs), servers, etc. When the image caption generation device is implemented as software, it can be installed on the aforementioned electronic devices. Based on the image caption generation device described above, the image caption generation method may include the following steps:
S201: obtaining an image to be processed and auxiliary caption information, wherein the image to be processed includes a main object, and the auxiliary caption information includes at least one of the following: name information corresponding to the main object, object category corresponding to the main object, an object attribute corresponding to the main object, and an image tag corresponding to the image to be processed.
S202: determining an image feature corresponding to the image to be processed, and an auxiliary feature corresponding to the auxiliary caption information.
S203: generating the caption based on the image feature and the auxiliary feature to obtain a target caption corresponding to the image to be processed, wherein the target caption includes the name information of the main object.

The following provides a detailed explanation of the specific implementation process and effects of each step described above:
S201: obtaining an image to be processed and auxiliary caption information, wherein the image to be processed includes a main object, and the auxiliary caption information includes at least one of the following: name information corresponding to the main object, object category corresponding to the main object, an object attribute corresponding to the main object, and an image tag corresponding to the image to be processed.

When the user has a need for generating image captions, in order to facilitate the caption generation operation, the image to be processed can be obtained. The image may include a plurality of types of views, such as six-view images of the main object, detailed display images, or zoomed-in images. Specifically, the image to be processed may contain one or more main objects. In different application scenarios, the main objects within the image may vary. For example, the main object could include any of the following: animals, plants, buildings, vehicles, food, clothing, electronic devices, and so on.

Additionally, this embodiment does not restrict the method of obtaining the image to be processed. In some instances, the image may be actively uploaded by the user. In this case, the image caption generation device is in communication with the request endpoint, and the image may be actively or passively transmitted by the request endpoint to the image caption generation device. In other instances, the image to be processed may be extracted from video information. In this case, obtaining the image may involve: acquiring the original video and performing keyframe extraction on the video to obtain the image to be processed, where the image corresponds to keyframes from the original video.

Additionally, to ensure the accuracy of the caption generation process, not only the image to be processed but also auxiliary caption information may be obtained. The method for obtaining this auxiliary information is not restricted in this embodiment. In some instances, the auxiliary caption information may be generated based on user interactions. In this case, acquiring the auxiliary caption information may involve the following steps: displaying an interface for user interaction, obtaining the user's input or actions on the display interface, and acquiring the auxiliary information based on those actions. In other instances, the auxiliary caption information may be stored on the client or request endpoint, which communicates with the image caption generation device. In such cases, the auxiliary caption information can be actively or passively obtained from the client or request endpoint.

Specifically, the acquired auxiliary caption information may correspond to the image to be processed and/or the main object. When the auxiliary information corresponds to the image to be processed, it may include image tags that correspond to the image. These image tags may include both entity tags and abstract tags. The entity tags may include categories such as: people, animals, plants, food, vehicles, everyday items, actions, scenes, weapons, healthcare, education, and others. The abstract tags may include categories such as: finance and business, sciences, beliefs, emotions, leisure and social interaction, events, society, and lifestyle. When the auxiliary information corresponds to the main object, it may include the following: title information corresponding to the main object, object category corresponding to the main object, and object attributes corresponding to the main object. Title information may include name information and title formatting, while the object category represents the category the main object belongs to. For example, object categories may include food, clothing, electronic devices, etc. Object attributes may include characteristics such as regional attributes, quality attributes, and functional attributes.

It should be noted that the auxiliary caption information may include not only the aforementioned types of information but also other relevant information not listed here. Those skilled in the art can configure the auxiliary caption information according to specific application scenarios or requirements, and thus, further details will not be elaborated upon here.

In some other embodiments, when the auxiliary caption information includes object attributes corresponding to the main object and image tags corresponding to the image to be processed, there may be instances where the image tags and object attributes share identical or overlapping features. Therefore, after acquiring the auxiliary caption information, the method in this embodiment can further include the following step: identifying whether there are any identical features between the image tags and object attributes. If such identical features are found, the method involves removing the duplicate features from the image tags, resulting in processed image tags.

Specifically, to ensure the quality and effectiveness of the auxiliary information acquisition, when the auxiliary caption information includes both object attributes and image tags, a comparison and analysis between the image tags and object attributes can be performed to identify whether any identical features exist. This can be achieved by calculating the similarity between each image tag and any given object attribute. If the similarity is greater than or equal to a predefined threshold (e.g., 99%, 99.9%, 98%, etc.), the image tag and the object attribute are determined to be identical features. If the similarity is less than the predefined threshold, they are considered different features. When identical features are found between the image tags and object attributes, the identical features within the image tags can be removed, resulting in processed image tags. This effectively avoids the repeated handling of duplicate features, which can help prevent a reduction in the accuracy of the image caption generation process.

It is important to note that after obtaining the processed image tags, their length can be compared to a predefined information length. If the length of the processed image tags is shorter than the required length, since the processed image tags are composed of a plurality of sub-tags, new sub-tags can be selected to meet the predefined length. Additionally, if no identical tags are found between the image tags and the object attributes, no processing is needed for the image tags or object attributes, and the original tags and attributes are retained. This ensures that the image caption generation process maintains a plurality of dimensions of auxiliary information, enhancing the diversity of the information and contributing to improved accuracy in the image caption generation process.

S202: determining an image feature corresponding to the image to be processed, and an auxiliary feature corresponding to the auxiliary caption information.

After acquiring the image to be processed, the next step involves analyzing the image to determine the corresponding image features, which represent the relevant properties of the image. For example, image features may include color features, texture features, shape features, and spatial relationship features. Color features are global features that describe the surface properties of objects or regions within the image, capturing color information; texture features are global, texture features describe the surface properties of objects or regions in terms of patterns or smoothness; shape features can be categorized into two types—contour features and region features; contour features focus on the outer boundary of objects, while region features relate to the entire shape of the object; spatial relationship features describe the spatial positions or relative directional relationships between a plurality of segmented targets within the image. Such relationships may include connection/adjacency, overlap, and inclusion/containment relationships.

Furthermore, this embodiment does not restrict the method of obtaining image features. In some instances, image features can be acquired by analyzing the image using pre-trained machine learning models or neural network models. In this case, determining the image features corresponding to the image to be processed may include the following: obtaining a pre-trained machine learning model or neural network model, inputting the image into the model, and acquiring the image features output by the model. In other instances, image features may be obtained by analyzing the image using a preset algorithm. These preset algorithms may include, for example, the Histogram of Oriented Gradients (HOG) feature extraction algorithm or the Local Binary Pattern (LBP) algorithm. It is important to note that different preset algorithms extract different image features, depending on the characteristics of the image and the specific algorithm being used.

In other embodiments, to more accurately obtain the image features corresponding to the image to be processed, the image can undergo segmentation to extract its features. In this case, determining the image features may include the following steps: segmenting the image into a plurality of image blocks, determining the position encoding for each image block, and processing these image blocks based on their respective position encodings to obtain the overall image features. This segmentation approach allows for a more detailed analysis of different areas of the image, helping to capture finer-grained features that may contribute to more accurate and contextually relevant image captions.

Specifically, after acquiring the image to be processed, to accurately obtain the image features, the image can be segmented into a plurality of image blocks. In some instances, segmenting the image to obtain a plurality of image blocks may involve the following steps: determining the number of image blocks to be created, and then performing the segmentation based on this number to divide the image into a plurality of blocks. In other instances, the segmentation process may be based on the size of the image blocks. For example, the image block size could be 42×42 pixels, 48×48 pixels, or 64×64 pixels, etc. After determining the block size, the image is segmented accordingly to generate a plurality of image blocks of the specified size. This method enables precise analysis of different parts of the image, which helps in extracting more detailed and accurate features for further processing.

After acquiring a plurality of image blocks, the image position codes corresponding to each image block can be determined either automatically or manually. Then, based on these position codes, the plurality of image blocks are processed to obtain image features, effectively ensuring the accuracy and reliability of image feature acquisition.

Similarly, after obtaining the auxiliary caption information, it can be analyzed to extract auxiliary features, which represent relevant textual properties of the auxiliary caption information. In some instances, auxiliary features may be obtained by processing the auxiliary caption information using pre-trained machine learning models or neural networks. In this case, determining the auxiliary features may include the following: acquiring a pre-trained machine learning or neural network model, inputting the auxiliary caption information into the model, and obtaining the auxiliary features output by the model. In other instances, auxiliary features can be extracted using preset algorithms applied to the auxiliary caption information. Such algorithms may include techniques like one-hot encoding or Term Frequency-Inverse Document Frequency (TF-IDF) algorithms. It should be noted that the auxiliary features extracted will vary depending on the algorithm used, as different preset algorithms capture different aspects of the textual data.

S203: generating the caption based on the image feature and the auxiliary feature to obtain a target caption corresponding to the image to be processed, wherein the target caption includes the name information of the main object.

After obtaining the image features and auxiliary features, the system can proceed with the caption generation operation based on these features to produce the target caption corresponding to the image. The target caption includes the name information of the main object, allowing users to quickly and intuitively understand the key object or theme represented in the image. This approach enhances user experience by providing clear and relevant information about the main object through the generated caption.

In some further embodiments, after obtaining the target caption corresponding to the image to be processed, the method in this embodiment may also include: integrating the target caption with the image to be processed. Specifically, the target caption can be inserted into a preset position within the image to be processed (such as the top, bottom, left, right, etc.) to obtain the target image, which includes the generated target caption. After generating the target image, the target image can be displayed, enabling users to quickly and intuitively understand the main object represented or conveyed by the image through the displayed target caption.

The image caption generation method provided in this embodiments involves obtaining the image to be processed along with auxiliary caption information, determining the image features corresponding to the image to be processed, as well as auxiliary features corresponding to the auxiliary caption information. The caption generation operation is then performed based on the image features and auxiliary features to obtain the target caption corresponding to the image. The target caption includes the name information of the main object, effectively achieving automated image caption generation. This technical solution is applicable to scenarios requiring the bulk generation of captions. Moreover, since the target caption is generated by incorporating auxiliary caption information from a plurality of dimensions, the accuracy and quality of the generated target caption are effectively ensured. Once the target caption is obtained, it can be displayed alongside the image to be processed, allowing users to quickly and intuitively understand the information conveyed by the image. This further enhances the practicality of the method and facilitates its promotion and application in the market.

FIG. 3 is a schematic flow diagram illustrating the process of determining auxiliary features corresponding to the auxiliary caption information, as provided by the embodiment of the present invention. Based on the aforementioned embodiment and with reference to FIG. 3, this embodiment provides an implementation solution for obtaining auxiliary features by performing word segmentation on the auxiliary caption information. Specifically, determining the auxiliary features corresponding to the auxiliary caption information may include the following steps:
S301: performing word segmentation on the auxiliary caption information to obtain a plurality of segmented word entries corresponding to the auxiliary caption information.

Since the auxiliary caption information may include various types of auxiliary information, in order to accurately obtain the auxiliary features of the auxiliary caption information, the auxiliary caption information can be analyzed after it is acquired to obtain a plurality of segmented word entries corresponding to the auxiliary caption information. In some instances, these plurality of segmented word entries may be obtained by analyzing the auxiliary caption information through a pre-trained machine learning model or neural network model. In this case, performing word segmentation on the auxiliary caption information to obtain the segmented word entries may include the following: acquiring a machine learning model or neural network model for implementing the word segmentation; and using the machine learning model or neural network model to perform word segmentation on the auxiliary caption information to obtain a plurality of segmented word entries corresponding to the auxiliary caption information.

In some further embodiments, aside from directly processing the auxiliary caption information using a machine learning model or neural network model, word segmentation can also be performed on the auxiliary caption information by considering the type of each auxiliary information. In this case, performing word segmentation on the auxiliary caption information to obtain a plurality of segmented word entries may include the following steps: acquiring the information type corresponding to the auxiliary caption information; determining the predefined information length for each auxiliary information based on its information type, where different information types correspond to different predefined information lengths; and performing word segmentation on each auxiliary information within the caption based on the predefined information length to obtain a plurality of segmented word entries corresponding to the auxiliary caption information.

Different auxiliary caption information may correspond to different identification information. Therefore, after acquiring the auxiliary caption information, the information type corresponding to the auxiliary caption information can be determined based on the identification information. Each type of auxiliary information is pre-configured with a predefined information length, which limits the maximum length of the corresponding auxiliary information. For example, if the auxiliary caption information includes name information, the predefined length for the name information could be set to 50, meaning the maximum length of the name information is 50 characters. If the auxiliary caption information includes an object category, the predefined length for the object category could be set to 20, meaning the maximum length of the object category is 20 characters. Similarly, if the auxiliary caption information includes object attributes, the predefined length for the object attributes could be set to 100, meaning the maximum length of the object attributes is 100 characters.

It is important to note that each type of auxiliary information may include a plurality of sub-auxiliary information entries. When acquiring each type of auxiliary information, if the original length of the auxiliary information is shorter than the predefined information length, empty values can be automatically filled to meet the predefined length. Conversely, if the original length of the auxiliary information exceeds the predefined information length, a portion of the sub-auxiliary information can be selectively filtered based on its importance, ensuring that the auxiliary information conforms to the predefined length.

Since the predefined information lengths for different types of auxiliary information are typically pre-configured, in order to improve the quality and effectiveness of the word segmentation process, the word segmentation can be performed on each auxiliary information entry based on its predefined length. This approach ensures that a plurality of segmented word entries corresponding to the auxiliary caption information are obtained with enhanced accuracy and reliability.

S302: determining a segmentation position corresponding to each of the plurality of segmented word entries.

After obtaining a plurality of segmented word entries, to accurately acquire the auxiliary features, the segmentation position corresponding to each word entry can be automatically determined. In some instances, determining the segmentation position corresponding to each word entry may include: acquiring the character sequence corresponding to each word entry in the text information, and determining the segmentation position of each word entry based on its character sequence within the text. This approach ensures the accuracy and reliability of determining the segmentation positions. In other instances, determining the segmentation position for each word entry may involve: acquiring the semantic meaning corresponding to each word entry, and determining the segmentation position of each word entry based on the semantic meanings of all the segmented word entries.

S303: processing word vectors corresponding to each of the plurality of segmented word entries based on their respective segmentation positions to obtain the auxiliary features.

After obtaining the segmentation position corresponding to each of the segmented word entries, the word vectors corresponding to each word entry can be processed based on their respective segmentation positions to obtain the auxiliary features. Specifically, processing the word vectors of all segmented word entries based on their segmentation positions to obtain auxiliary features may include: performing addition, multiplication, or concatenation of each word entry's segmentation position with its corresponding word vector, thereby generating the auxiliary features.

For example, after performing word segmentation on the auxiliary caption information, the obtained segmented word entries may include word entry a, word entry b, word entry c, and word entry d. The corresponding positional information for these word entries could be: word entry a—position 3, word entry b—position 2, word entry c—position 1, and word entry d—position 4. After acquiring these word entries and their respective positional information, auxiliary feature 1 can be obtained by adding word entry a and position 3. Similarly, auxiliary feature 2 can be obtained by adding word entry b and position 2; auxiliary feature 3 can be obtained by adding word entry c and position 1; and auxiliary feature 4 can be obtained by adding word entry d and position 4, thus generating a plurality of auxiliary features.

In this embodiment, by performing word segmentation on the auxiliary caption information, a plurality of segmented word entries corresponding to the auxiliary caption information are obtained. Then, the segmentation position for each word entry is determined. Based on these segmentation positions, the word vectors corresponding to each segmented word entry are processed to obtain the auxiliary features. This approach effectively ensures the accurate acquisition of auxiliary features, which in turn guarantees the quality and efficiency of the caption generation based on these auxiliary features.

FIG. 4 is a schematic flow diagram illustrating another method for generating image captions according to an embodiment of the present invention. Based on the aforementioned embodiment, and with reference to FIG. 4, when the auxiliary caption information does not include the object category corresponding to the main object, this embodiment provides a solution for image classification. Specifically, the method in this embodiment may include the following steps:
S401: obtaining the object category of the main object in the image to be processed based on the image feature and the auxiliary feature.
S402: performing image classification based on the object category and the name information of the main object.

When the auxiliary caption information does not include the object category of the main object, the process of generating the image caption can also involve image classification based on the object category of the main object. Specifically, after obtaining the image features and auxiliary features, these features can be processed to determine the object category of the main object in the image to be processed. Subsequently, image classification can be performed based on the object category and the name information of the main object, effectively ensuring the accurate determination of the image category corresponding to the image to be processed.

In this embodiment, after obtaining the target caption corresponding to the image to be processed, the object category of the main object in the image is determined based on the image features and auxiliary features. Then, image classification is performed based on the object category and the name information of the main object. This effectively achieves accurate image classification, allowing for subsequent image management operations based on the category of the image to be processed, further enhancing the practicality of the method.

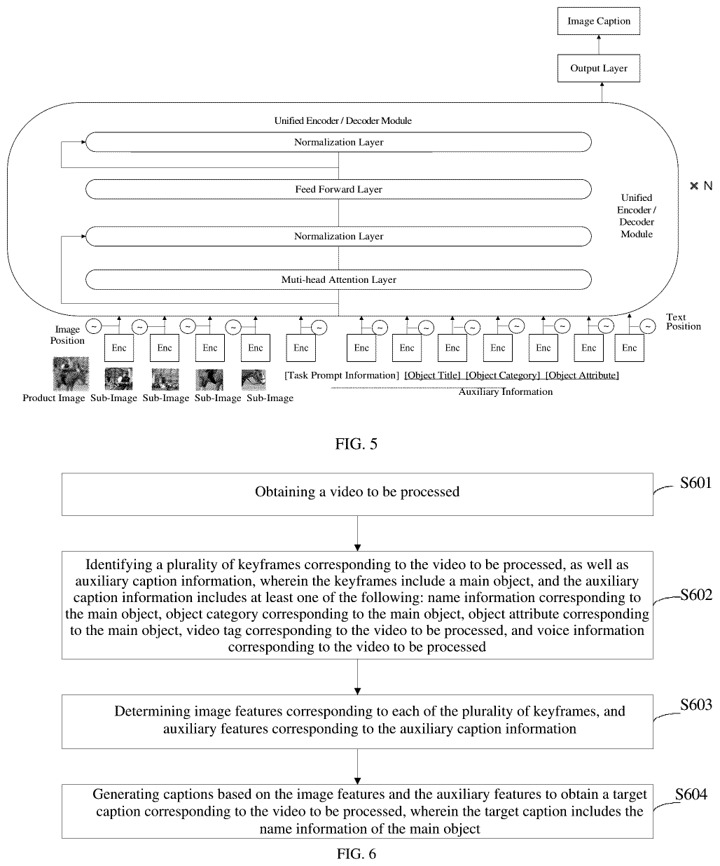

In practical applications, with reference to FIG. 5, and taking a product image as an example of an image to be processed, this embodiment provides a method for generating image captions using the M6 model. Specifically, the implementation principle of this method can be as follows: after obtaining the product image, product title, product category, and product attributes, these elements can be used as model inputs. The product image, product title, product category, and product attributes are input into the M6-OFA-keyword model, resulting in one or more target captions generated by the model. Specifically, the method for generating image captions includes the following steps:

S1: obtaining task prompt information corresponding to the product image, as well as auxiliary caption information. This auxiliary information may include the object title, object category, and object attributes.

The task prompt information can be pre-configured request information used to initiate the caption generation process, or it can be automatically generated. For example, the task prompt could be “What is the description of the image?” When the product image includes a product, the object title could be the product title, the object category could be the product category, and the object attributes could be the product attributes.

S2: performing segmentation on the product image to obtain a plurality of pixel blocks, and determine the hidden vector for each pixel block.

Specifically, the size of each pixel block can be 42*42 or another size. After obtaining the plurality of pixel blocks, each pixel block is converted into its corresponding hidden vector using the pre-trained ResNet model within the M6-OFA model.

S3: determining the positional vector corresponding to each pixel block, and obtain the target hidden vector for each pixel block based on the positional vector.

Specifically, the hidden vector of each pixel block is combined with its positional vector through addition, multiplication, or concatenation to generate the target hidden vector for each image pixel block. This target hidden vector serves as the image feature representing the relevant information of the product image. It is worth noting that in some scenarios, segmentation of the product image may not be necessary, and the product image can be processed directly. In such cases, since the image is not segmented, there is no need to obtain positional vectors, and the target hidden vector for the product image can still be generated.

S4: after obtaining the task prompt information, the task prompt can be concatenated with the object title, object category, and object attributes. Then, each segmented word's word vector is generated using the pre-trained word vector model in the M6-OFA.

S5: determining the positional vector corresponding to each segmented word, and obtain the target word vector for each segmented word based on its positional vector.

Specifically, the word vector of each segmented word is combined with its corresponding positional vector through addition, multiplication, or concatenation to generate the target word vector. This target word vector serves as the auxiliary feature corresponding to the text auxiliary information mentioned in the previous embodiment.

S6: using the pre-trained M6 model to process each target hidden vector and each target word vector to generate the target caption corresponding to the product image.

The M6 model can adopt an Encoder-Decoder architecture, where both the encoder and decoder may include 6 layers. Each layer of the encoder and decoder is based on a Transformer network structure.

It is important to note that the number of network layers in the encoder and decoder is not limited to the 6 layers described above. A person skilled in the art can automatically or passively adjust the number of layers based on specific application scenarios or requirements. Specifically, the method in this embodiment may also include: obtaining the time limit requirement for the caption generation process, determining the number of network layers corresponding to the time limit requirement, and adjusting the number of layers in the encoder and decoder accordingly to meet the time constraint. For example, if the caption generation time limit is less than or equal to 100 ms, the encoder and decoder may both be configured with 3layers; if the time limit is greater than 100 ms but less than or equal to 500 ms, the encoder and decoder may both be configured with 6 layers; if the time limit is greater than 500 ms but less than or equal to 2 seconds, the encoder and decoder may both be configured with 12 layers. This ensures that the image caption generation process meets the user's time requirements, improving the practicality of the method.

S7: after obtaining the target caption, determine the standard caption corresponding to the target caption. Based on the standard caption and the target caption, calculate the Sequence Length Loss of the image caption. Using the actual caption loss and the Adam optimization algorithm, continuously optimize the M6 model, resulting in an optimized network model.

After obtaining the target caption and the standard caption, an analysis and calculation can be performed on both to obtain the actual caption loss. It is important to note that when calculating the actual caption loss, the loss can be directly calculated between the target caption and the standard caption, regardless of whether their lengths are the same. The actual caption loss can represent the average or total loss of all caption characters. When the target caption is shorter than the standard caption, there is no need to perform padding operations on the target caption. Since the target caption does not include padding data (pad fields), it avoids the inclusion of meaningless padding fields, thus effectively improving the accuracy of obtaining the actual caption loss.

Through experimental comparison, the technical effects achieved by this solution are as follows: the algorithm evaluation metric CIDEr can reach 0.8179, the grammatical accuracy of the generated text can reach 92.69%, the average length of the generated text can reach 17.5154, and the repetition rate of the generated text can reach 5.77%. In terms of manual evaluation metrics, the relevance between the image and the generated text can reach 93.487%, the match rate between the image and the generated text can reach 91.5832%, the readability of the generated text can reach 3.980962, and the accuracy rate of identifying the product as the main subject in the generated text can reach 87.8758%. This effectively demonstrates the accuracy of the generated captions.

The technical solution provided in this embodiment enables the M6-OFA-Keyword model to automatically identify the main subject of product images and generate product captions that describe the characteristics of the product's main subject. This effectively overcomes the issue of error propagation found in the two-stage generation models of prior technologies. Specifically, it can generate a variety of image captions that meet different needs, greatly reducing labor costs and achieving the goal of cost reduction and efficiency improvement. Additionally, since the target caption incorporates product titles, categories, and attributes, the model is supplied with more prior knowledge. Position encoding is also added to the input images and text, which not only enriches the input data but also ensures that the generated target captions are more accurate. As a result, the generated captions more precisely represent the product's main subject, overcoming the limitation of missing subjects in captions generated by existing technologies.

Additionally, after obtaining the target caption, the caption can be integrated with the product image to obtain the target image, which can then be displayed. This allows the generated target image to clearly convey the product's main subject, with fluent text that is strongly related to the main object in the product image. Since the generated image captions are attractive and can accurately, vividly, and diversely describe the product image, they enhance the richness of the page's information and improve the relevance of image searches. As a result, this solution helps increase user engagement and revenue, further enhancing the practicality of this technical solution and promoting its application in the market.

FIG. 6 is a schematic flow diagram illustrating a method for generating video captions according to an embodiment of the present invention. With reference to FIG. 6, this embodiment provides a method for generating video captions, where the execution entity is a video caption generation device. It can be understood that the video caption generation device can be implemented as software or a combination of software and hardware. Specifically, the method for generating video captions may include the following steps:
S601: obtaining a video to be processed.
S602: identifying a plurality of keyframes corresponding to the video to be processed, along with auxiliary caption information. The keyframes include a main object, and the auxiliary caption information corresponds to the video to be processed and/or the main object.

The auxiliary caption information may include at least one of the following: name information corresponding to the main object, object category corresponding to the main object, object attribute corresponding to the main object, video tag corresponding to the video to be processed, and voice information corresponding to the video to be processed, among others.
S603: determining image features corresponding to each of the plurality of keyframes, and auxiliary features corresponding to the auxiliary caption information.
S604: generating captions based on the image features and the auxiliary features to obtain a target caption corresponding to the video to be processed, wherein the target caption includes the name information of the main object.

In this embodiment, the specific implementation process and effects of each step are similar to those described in the embodiment shown in FIG. 2. For detailed reference, please refer to the previous description. These details will not be repeated here.

Additionally, this embodiment may also include other method steps from the embodiments shown in FIGS. 1-5. For parts not described in detail in this embodiment, reference can be made to the relevant explanations of the embodiments shown in FIGS. 1-5. The execution process and technical effects of this technical solution can be found in the descriptions of the embodiments shown in FIGS. 1-5, and will not be repeated here.

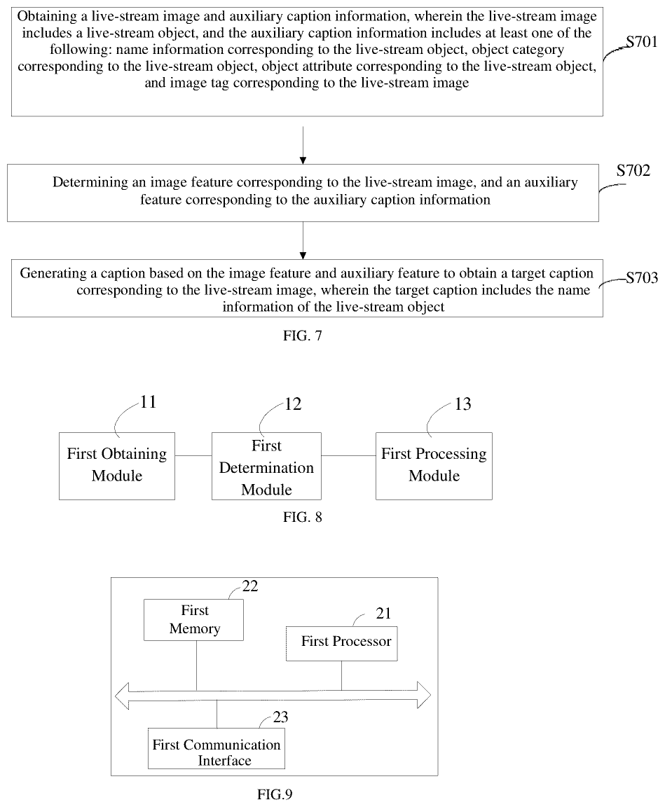

FIG. 7 is a schematic flow diagram illustrating a method for generating captions for live-stream images according to an embodiment of the present invention. With reference to FIG. 7, this embodiment provides a method for generating captions for live-stream images, where the execution entity is a caption generation device for live-stream images. It can be understood that this live-stream caption generation device can be implemented as software or a combination of software and hardware. Specifically, the live-stream image caption generation method may include the following steps:
S701: obtaining a live-stream image and auxiliary caption information, wherein the live-stream image includes a live-stream object, and the auxiliary caption information includes at least one of the following: name information corresponding to the live-stream object, object category corresponding to the live-stream object, object attribute corresponding to the live-stream object, and image tag corresponding to the live-stream image.
S702: determining an image feature corresponding to the live-stream image, and an auxiliary feature corresponding to the auxiliary caption information.

S703: generating a caption based on the image feature and auxiliary feature to obtain a target caption corresponding to the live-stream image, wherein the target caption includes the name information of the live-stream object.

In this embodiment, the specific implementation process and effects of each step are similar to those described in the embodiment shown in FIG. 2. For detailed reference, please refer to the previous descriptions. These details will not be repeated here.

Additionally, this embodiment may also include other method steps from the embodiments shown in FIGS. 1-5. For parts not described in detail in this embodiment, reference can be made to the relevant explanations of the embodiments shown in FIGS. 1-5. The execution process and technical effects of this technical solution can be found in the descriptions of the embodiments shown in FIGS. 1-5, and will not be repeated here.

FIG. 8 is a schematic structural diagram of an image caption generation device provided by an embodiment of the present invention. With reference to FIG. 8, this embodiment provides an image caption generation device, which can execute the image caption generation method shown in FIG. 2. The image caption generation device may include the following components:
a first acquisition module 11, configured to obtain the image to be processed and auxiliary caption information. The image to be processed includes the main object, and the auxiliary caption information includes at least one of the following: name information corresponding to the main object, object category corresponding to the main object, object attributes corresponding to the main object, and image tags corresponding to the image to be processed;
a first determination module 12, configured to determine the image features corresponding to the image to be processed, as well as the auxiliary features corresponding to the auxiliary caption information;
a first processing module 13, configured to perform caption generation based on the image features and auxiliary features, to obtain the target caption corresponding to the image to be processed. The target caption includes the name information of the main object.

In some embodiments, when the first determination module 12 determines the auxiliary features corresponding to the auxiliary caption information, the first determination module 12 is configured to perform the following: perform word segmentation on the auxiliary caption information to obtain a plurality of segmented word entries corresponding to the auxiliary caption information; determine the segmentation position corresponding to each of the segmented word entries; and process the word vectors corresponding to each of the segmented word entries based on their respective segmentation positions to obtain the auxiliary features.

In some embodiments, when the first determination module 12 performs word segmentation on the auxiliary caption information to obtain a plurality of segmented word entries corresponding to the auxiliary caption information, the first determination module 12 is configured to: acquire the information type corresponding to the auxiliary caption information; determine the predefined information length for each auxiliary information based on its information type, where different information types have different predefined lengths; and perform word segmentation on each auxiliary information within the auxiliary caption information based on its predefined length to obtain a plurality of segmented word entries corresponding to the auxiliary caption information.

In some embodiments, when the auxiliary caption information includes the object attributes corresponding to the main object and the image tags corresponding to the image to be processed, after acquiring the auxiliary caption information, the first processing module 13 in this embodiment is configured to perform the following steps: identify whether there are matching features between the image tags and the object attributes; and if matching features are found between the image tags and the object attributes, remove the matching features from the image tags to obtain the processed image tags.

In some embodiments, when the first determination module 12 determines the image features corresponding to the image to be processed, the first determination module 12 is configured to perform the following: segment the image to be processed to obtain a plurality of image blocks; determine the positional encoding corresponding to each image block; and process the image blocks based on their respective positional encodings to obtain the image features.

In some embodiments, when the auxiliary caption information does not include the object category corresponding to the main object, after obtaining the target caption corresponding to the image to be processed, the first acquisition module 11 and the first processing module 13 in this embodiment are configured to perform the following steps:
the first acquisition module 11 is configured to obtain the object category of the main object in the image to be processed based on the image features and auxiliary features;
the first processing module 13 is configured to perform image classification based on the object category and the name information of the main object.

The device shown in FIG. 8 can execute the method of the embodiments illustrated in FIGS. 1-5. For parts not described in detail in this embodiment, reference can be made to the relevant explanations of the embodiments shown in FIGS. 1-5. The execution process and technical effects of this technical solution can be found in the descriptions of the embodiments shown in FIGS. 1-5 and will not be repeated here.

In a possible design, the structure of the image caption generation device shown in FIG. 8 can be implemented as an electronic device, which may be a controller, personal computer, server, or other similar equipment. As shown in FIG. 9, the electronic device may include: a first processor 21 and a first memory 22. The first memory 22 is used to store the program corresponding to the image caption generation method provided in the embodiments shown in FIGS. 1-5, and the first processor 21 is configured to execute the program stored in the first memory 22.

The program includes one or more computer instructions, which, when executed by the first processor 21, are capable of performing the following steps: obtaining the image to be processed and auxiliary caption information, where the image to be processed includes the main object, and the auxiliary caption information includes at least one of the following: name information corresponding to the main object, object category corresponding to the main object, object attributes corresponding to the main object, and image tags corresponding to the image to be processed; determining the image features corresponding to the image to be processed, as well as the auxiliary features corresponding to the auxiliary caption information; performing caption generation based on the image features and auxiliary features to obtain the target caption corresponding to the image to be processed, where the target caption includes the name information of the main object.

Furthermore, the first processor 21 is also configured to execute all or part of the steps described in the embodiments shown in FIGS. 1-5.

The structure of the electronic device may also include a first communication interface 23, which is used for communication between the electronic device and other devices or communication networks.

Additionally, an embodiment of the present invention provides a computer storage medium for storing the computer software instructions used by the electronic device. This storage medium contains the program for executing the image caption generation method described in the embodiments shown in FIGS. 1-5.

Furthermore, the embodiment of the present invention provides a computer program product, which includes a computer-readable storage medium storing computer instructions. When these instructions are executed by one or more processors, they cause the one or more processors to execute the steps of the image caption generation method described in the embodiments shown in FIGS. 1-5.

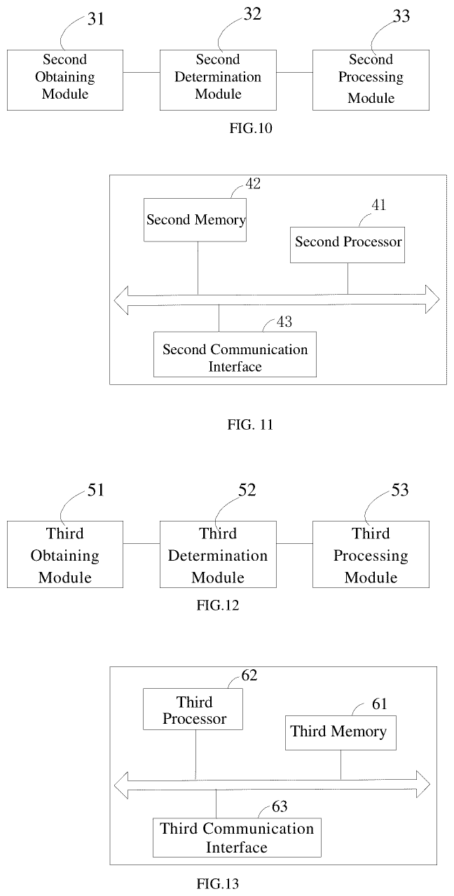

FIG. 10 is a schematic structural diagram of a video caption generation device provided by an embodiment of the present invention. With reference to FIG. 10, this embodiment provides a video caption generation device, which can execute the video caption generation method shown in FIG. 6. The video caption generation device may include the following:
a second acquisition module 31, configured to obtain the video to be processed;
a second determination module 32, configured to identify a plurality of keyframes corresponding to the video to be processed, as well as auxiliary caption information. The keyframes include the main object, and the auxiliary caption information includes at least one of the following: name information corresponding to the main object, object category corresponding to the main object, object attributes corresponding to the main object, video tags corresponding to the video to be processed, and voice information corresponding to the video to be processed;
the second determination module 32 is configured to determine the image features corresponding to each of the plurality of keyframes, as well as the auxiliary features corresponding to the auxiliary caption information;
the second processing module 33 is configured to perform caption generation based on the image features and auxiliary features to obtain the target caption corresponding to the video to be processed. The target caption includes the name information of the main object.

The device shown in FIG. 10 can also execute the methods described in the embodiments shown in FIGS. 1-6. For parts not described in detail in this embodiment, reference can be made to the relevant explanations of the embodiments shown in FIGS. 1-6. The execution process and technical effects of this technical solution can be found in the descriptions of the embodiments shown in FIGS. 1-6 and will not be repeated here.

In a possible design, the structure of the video caption generation device shown in FIG. 10 can be implemented as an electronic device, such as a controller, personal computer, server, or other similar equipment. As shown in FIG. 11, the electronic device may include: a second processor 41 and a second memory 42. The second memory 42 is used to store the program corresponding to the video caption generation method provided in the embodiments shown in FIGS. 1-6, and the second processor 41 is configured to execute the program stored in the second memory 42.

The program includes one or more computer instructions, which, when executed by the second processor 41, are capable of performing the following steps: obtaining the video to be processed; identifying a plurality of keyframes corresponding to the video to be processed, as well as auxiliary caption information, where the keyframes include the main object, and the auxiliary caption information includes at least one of the following: name information corresponding to the main object, object category corresponding to the main object, object attributes corresponding to the main object, video tags corresponding to the video to be processed, and voice information corresponding to the video to be processed; determining the image features corresponding to each of the plurality of keyframes, as well as the auxiliary features corresponding to the auxiliary caption information; and performing caption generation based on the image features and auxiliary features to obtain the target caption corresponding to the video to be processed, where the target caption includes the name information of the main object.

Furthermore, the second processor 41 is also configured to execute all or part of the steps described in the embodiments shown in FIGS. 1-6.

The structure of the electronic device may also include a second communication interface 43, which is used for communication between the electronic device and other devices or communication networks.

Additionally, an embodiment of the present invention provides a computer storage medium for storing the computer software instructions used by the electronic device. This storage medium contains the program for executing the video caption generation method described in the embodiments shown in FIGS. 1-6.

Furthermore, an embodiment of the present invention provides a computer program product, which includes a computer-readable storage medium storing computer instructions. When these instructions are executed by one or more processors, they cause the one or more processors to execute the steps of the video caption generation method described in the embodiments shown in FIGS. 1-6.

FIG. 12 is a schematic structural diagram of a live-stream image caption generation device provided by an embodiment of the present invention. With reference to FIG. 12, this embodiment provides a live-stream image caption generation device, which can execute the live-stream image caption generation method shown in FIG. 7. The live-stream image caption generation device may include the following components:
a third acquisition module 51, configured to obtain the live-stream image and auxiliary caption information, where the live-stream image includes the live-stream object. The auxiliary caption information includes at least one of the following: name information corresponding to the live-stream object, object category corresponding to the live-stream object, object attributes corresponding to the live-stream object, and image tags corresponding to the live-stream image;
a third determination module 52, configured to determine the image features corresponding to the live-stream image, as well as the auxiliary features corresponding to the auxiliary caption information;
a third processing module 53, configured to perform caption generation based on the image features and auxiliary features to obtain the target caption corresponding to the live-stream image. The target caption includes the name information of the live-stream object.

The device shown in FIG. 12 can also execute the methods described in the embodiments shown in FIGS. 1-7. For parts not described in detail in this embodiment, reference can be made to the relevant explanations of the embodiments shown in FIGS. 1-7. The execution process and technical effects of this technical solution can be found in the descriptions of the embodiments shown in FIGS. 1-7 and will not be repeated here.

In a possible design, the structure of the live-stream image caption generation device shown in FIG. 12 can be implemented as an electronic device, such as a controller, personal computer, server, or other similar equipment. As shown in FIG. 13, the electronic device may include: a third processor 61 and a third memory 62. The third memory 62 is used to store the program corresponding to the live-stream image caption generation method provided in the embodiments shown in FIGS. 1-7, and the third processor 61 is configured to execute the program stored in the third memory 62.

The program includes one or more computer instructions, which, when executed by the third processor 61, are capable of performing the following steps: obtaining the live-stream image and auxiliary caption information, where the live-stream image includes the live-stream object, and the auxiliary caption information includes at least one of the following: name information corresponding to the live-stream object, object category corresponding to the live-stream object, object attributes corresponding to the live-stream object, and image tags corresponding to the live-stream image; determining the image features corresponding to the live-stream image, as well as the auxiliary features corresponding to the auxiliary caption information; performing caption generation based on the image features and auxiliary features to obtain the target caption corresponding to the live-stream image, where the target caption includes the name information of the live-stream object.

Furthermore, the third processor 61 is also configured to execute all or part of the steps described in the embodiments shown in FIGS. 1-7. The structure of the electronic device may also include a third communication interface 63, which is used for communication between the electronic device and other devices or communication networks.

Additionally, an embodiment of the present invention provides a computer storage medium for storing the computer software instructions used by the electronic device. This storage medium contains the program for executing the live-stream image caption generation method described in the embodiments shown in FIGS. 1-7.

Furthermore, an embodiment of the present invention provides a computer program product, which includes a computer-readable storage medium storing computer instructions. When these instructions are executed by one or more processors, they cause the one or more processors to execute the steps of the live-stream image caption generation method described in the embodiments shown in FIGS. 1-7.

The device embodiments described above are merely illustrative. The units described as separate components may or may not be physically separate, and the components displayed as units may or may not be physical units, meaning they could be located in one place or distributed across a plurality of network units. Parts or all of the modules can be selected as needed to achieve the objectives of this embodiment. Those of ordinary skill in the art can easily understand and implement these embodiments without creative effort.

From the description of the above embodiments, it can be clearly understood by those skilled in the art that each embodiment can be implemented using necessary general hardware platforms, and of course, it can also be implemented through a combination of hardware and software. Based on this understanding, the technical solutions described above, or the parts contributing to the prior art, can be embodied in the form of a computer product. The present invention may be implemented as a computer program product on one or more computer-readable storage media (including but not limited to magnetic disk storage, CD-ROM, optical storage, etc.) containing computer-usable program code.

The present invention is described with reference to the flowcharts and/or block diagrams of methods, devices (systems), and computer program products according to embodiments of the present invention. It should be understood that each flow and/or block in the flowcharts and/or block diagrams, as well as combinations of flows and/or blocks, can be implemented by computer program instructions. These computer program instructions can be provided to a general-purpose computer, a special-purpose computer, an embedded processor, or other programmable devices' processors to produce a machine. When executed by a processor of a computer or other programmable device, these instructions create mechanisms for implementing the functions specified in one or more flows in the flowchart and/or one or more blocks in the block diagram.

These computer program instructions can also be stored in a computer-readable storage medium that can direct a computer or other programmable devices to operate in a specific manner, such that the instructions stored in the computer-readable storage medium produce an article of manufacture that includes instruction means for implementing the functions specified in one or more flows in the flowchart and/or one or more blocks in the block diagram.

These computer program instructions can also be loaded onto a computer or other programmable devices, causing a series of operational steps to be executed on the computer or other programmable devices to produce a computer-implemented process. As a result, the instructions executed on the computer or other programmable devices provide steps for implementing the functions specified in one or more flows in the flowchart and/or one or more blocks in the block diagram.

In a typical configuration, a computing device includes one or more processors (CPU), input/output interfaces, network interfaces, and memory. The memory may include non-persistent storage in the form of computer-readable media, such as random access memory (RAM), and/or non-volatile memory, such as read-only memory (ROM) or flash memory (flash RAM). The memory is an example of computer-readable media.

Computer-readable media include both persistent and non-persistent, removable and non-removable media that store information using any method or technology. The information may include computer-readable instructions, data structures, program modules, or other data. Examples of computer-readable storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile discs (DVDs) or other optical storage, magnetic tapes, magnetic disks, or other magnetic storage devices, or any other non-transitory media capable of storing information that can be accessed by a computing device. As defined herein, computer-readable media do not include transitory media such as modulated data signals and carrier waves.

Finally, it should be noted that the above embodiments are intended only to illustrate the technical solutions of the present invention, and not to limit them. Although the present invention has been described in detail with reference to the foregoing embodiments, those of ordinary skill in the art should understand that they can still make modifications to the technical solutions described in the foregoing embodiments, or make equivalent replacements for some of the technical features. Such modifications or replacements do not depart from the essence and scope of the technical solutions of the embodiments of the present invention.

What is claimed is:

1. A method for generating an image caption, comprising:
obtaining an image to be processed and auxiliary caption information, wherein the image to be processed includes a main object, and the auxiliary caption information includes at least one of the following: name information corresponding to the main object, object category corresponding to the main object, an object attribute corresponding to the main object, and an image tag corresponding to the image to be processed;
determining an image feature corresponding to the image to be processed, and an auxiliary feature corresponding to the auxiliary caption information;
generating, based on the image feature and the auxiliary feature, a target caption corresponding to the image to be processed, wherein the target caption includes the name information of the main object.

2. The method according to claim 1, wherein determining the auxiliary feature corresponding to the auxiliary caption information comprises:
performing word segmentation on the auxiliary caption information to obtain a plurality of segmented word entries corresponding to the auxiliary caption information;
determining a segmentation position corresponding to each of the plurality of segmented word entries;
processing word vectors corresponding to each of the plurality of segmented word entries based on their respective segmentation positions to obtain the auxiliary feature.

3. The method according to claim 2, wherein performing word segmentation on the auxiliary caption information to obtain a plurality of segmented word entries corresponding to the auxiliary caption information comprises:
acquiring an information type corresponding to the auxiliary caption information;
determining a predefined information length for each piece of auxiliary information based on the information type, wherein different types of auxiliary information correspond to different predefined information lengths;
performing word segmentation on each piece of auxiliary information within the auxiliary caption information based on the predefined information length to obtain a plurality of segmented word entries corresponding to the auxiliary caption information.

4. The method according to claim 3, wherein when the auxiliary caption information includes an object attribute corresponding to the main object and an image tag corresponding to the image to be processed, the method further comprises:
identifying whether there is a matching feature between the image tag and the object attribute;
removing the matching feature from the image tag when such matching feature is found between the image tag and the object attribute, to obtain a processed image tag.

5. The method according to claim 1, wherein determining the image feature corresponding to the image to be processed comprises:
segmenting the image to be processed to obtain a plurality of image blocks;
determining a positional encoding corresponding to each of the plurality of image blocks;
processing the plurality of image blocks based on their respective positional encodings to obtain the image feature.

6. The method according to claim 1, wherein when the auxiliary caption information does not include the object category corresponding to the main object, the method further comprises:
obtaining the object category of the main object in the image to be processed based on the image feature and the auxiliary feature;
performing image classification based on the object category and the name information of the main object.

7. A non-transitory computer-readable storage medium configured with instructions executable by one or more processors to cause the one or more processors to perform the method of claim 1.

8. An electronic device comprising:
one or more processors; and
one or more computer-readable memories coupled to the one or more processors and having instructions stored thereon that are executable by the one or more processors to perform the method of claim 1.

9. A method for generating a video caption, comprising:
obtaining a video to be processed;
identifying a plurality of keyframes corresponding to the video to be processed, and auxiliary caption information, wherein the keyframes include a main object, and the auxiliary caption information includes at least one of the following: name information corresponding to the main object, object category corresponding to the main object, object attribute corresponding to the main object, video tag corresponding to the video to be processed, and voice information corresponding to the video to be processed;
determining an image feature corresponding to each of the plurality of keyframes, and auxiliary features corresponding to the auxiliary caption information;
generating, based on the image features and the auxiliary features, a target caption corresponding to the video to be processed, wherein the target caption includes the name information of the main object.

10. The method according to claim 9, wherein determining the auxiliary features corresponding to the auxiliary caption information comprises:
performing word segmentation on the auxiliary caption information to obtain a plurality of segmented word entries corresponding to the auxiliary caption information;
determining a segmentation position corresponding to each of the plurality of segmented word entries;
processing word vectors corresponding to each of the plurality of segmented word entries based on their respective segmentation positions to obtain the auxiliary features.

11. The method according to claim 10, wherein performing word segmentation on the auxiliary caption information to obtain a plurality of segmented word entries corresponding to the auxiliary caption information comprises:
acquiring an information type corresponding to the auxiliary caption information;
determining a predefined information length for each piece of auxiliary information based on the information type, wherein different types of auxiliary information correspond to different predefined information lengths;
performing word segmentation on each piece of auxiliary information within the auxiliary caption information based on the predefined information length to obtain a plurality of segmented word entries corresponding to the auxiliary caption information.

12. The method according to claim 9, wherein determining the image feature corresponding to each of the plurality of keyframes comprises:
for each of the plurality of keyframes:
segmenting the image to be processed to obtain a plurality of image blocks;
determining a positional encoding corresponding to each of the plurality of image blocks;
processing the plurality of image blocks based on their respective positional encodings to obtain the image feature.

13. The method according to claim 9, wherein when the auxiliary caption information does not include the object category corresponding to the main object, the method further comprises:
obtaining the object category of the main object in the key frames based on the image features and the auxiliary features;
performing image classification based on the object category and the name information of the main object.

14. A non-transitory computer-readable storage medium configured with instructions executable by one or more processors to cause the one or more processors to perform the method of claim 9.

15. An electronic device comprising:
one or more processors; and
one or more computer-readable memories coupled to the one or more processors and having instructions stored thereon that are executable by the one or more processors to perform the method of claim 9.

16. A method for generating a caption for a live-stream image, comprising:
obtaining a live-stream image and auxiliary caption information, wherein the live-stream image includes a live-stream object, and the auxiliary caption information includes at least one of the following: name information corresponding to the live-stream object, object category corresponding to the live-stream object, object attribute corresponding to the live-stream object, and image tag corresponding to the live-stream image;
determining an image feature corresponding to the live-stream image, and an auxiliary feature corresponding to the auxiliary caption information;
generating, based on the image feature and auxiliary feature, a target caption corresponding to the live-stream image, wherein the target caption includes the name information of the live-stream object.

17. The method according to claim 16, wherein determining the auxiliary feature corresponding to the auxiliary caption information comprises:
performing word segmentation on the auxiliary caption information to obtain a plurality of segmented word entries corresponding to the auxiliary caption information;
determining a segmentation position corresponding to each of the plurality of segmented word entries;
processing word vectors corresponding to each of the plurality of segmented word entries based on their respective segmentation positions to obtain the auxiliary features.

18. The method according to claim 17, wherein performing word segmentation on the auxiliary caption information to obtain a plurality of segmented word entries corresponding to the auxiliary caption information comprises:
acquiring an information type corresponding to the auxiliary caption information;
determining a predefined information length for each piece of auxiliary information based on the information type, wherein different types of auxiliary information correspond to different predefined information lengths;
performing word segmentation on each piece of auxiliary information within the auxiliary caption information based on the predefined information length to obtain a plurality of segmented word entries corresponding to the auxiliary caption information.

19. The method according to claim 16, wherein determining the image feature corresponding to the live-stream image comprises:
segmenting the live-stream image to obtain a plurality of image blocks;
determining a positional encoding corresponding to each of the plurality of image blocks;
processing the plurality of image blocks based on their respective positional encodings to obtain the image feature.

20. The method according to claim 16, wherein when the auxiliary caption information does not include the object category corresponding to the live-stream object, the method further comprises:
obtaining the object category of the live-stream object in the key frames based on the image features and the auxiliary features;
performing image classification based on the object category and the name information of the live-stream object.
